(19) United States
(12) Patent Application Publication
(10) Pub. No.: US 2005/0125236 A1
(43) Pub. Date: Jun. 9, 2005

(54) Automatic capture of intonation cues in audio segments for speech applications

(75) Inventors: Ciprian Agapi, Lake Worth, FL (US); Felipe Gomez, Weston, FL (US); James R. Lewis, Delray Beach, FL (US); Vanessa V. Michelini, Boca Raton, FL (US); Sibyl C. Sullivan, Highland Beach, FL (US)

Correspondence Address: CHRISTOPHER & WEISBERG PA, 200 E LAS OLAS BLVD, SUITE 2040, FT LAUDERDALE, FL, 33301, US

(73) Assignee: International Business Machines Corporation, Armonk, NY (US)

(21) Appl. No.: 10/956,569

(22) Filed: Oct. 1, 2004

Related U.S. Application Data
(63) Continuation-in-part of application No. 10/730,540, filed on Dec. 8, 2003.

(51) Int. Cl. G10L 21/00

(52) U.S. Cl. 704/275

(57) ABSTRACT

A method, system and apparatus for automatically capturing intonation cues in audio segments in speech applications. The method can include identifying planned audio segments in the speech application program, the audio segments containing audio text to be recorded and associated file names. The method further can include extracting the audio segments from the speech application program and processing the extracted audio segments to create an audio text recordation plan. Finally, the method can include further processing the audio text recordation plan to account for intonation cues.

### CROSS-REFERENCE TO RELATED APPLICATIONS

This patent application claims the benefit under 35 U.S.C. § 120 as a continuation-in-part of presently pending U.S. patent application Ser. No. 10/730,540, entitled AUTOMATIC IDENTIFICATION OF OPTIMAL AUDIO SEGMENTS FOR SPEECH APPLICATIONS, filed on Dec. 8, 2003, the entire teachings of which are incorporated herein by reference.

### BACKGROUND OF THE INVENTION

1. Statement of the Technical Field

The present invention relates to the field of interactive voice response systems and more particularly to a method and system that automatically identifies and optimizes planned audio segments in a speech application program in order to facilitate recording of audio text.

2. Description of the Related Art

In a typical interactive voice response (IVR) application, certain elements of the underlying source code indicate the presence of an audio file. In a well-designed application, there will also be text that documents the planned contents of the audio file. There are inherent difficulties in the process of identifying and extracting audio files and audio file content from the source code in order to efficiently create audio segments.

Because voice segments in IVR applications are often recorded professionally, it is time and cost effective to provide the voice recording professional with a workable text output that can be easily converted into an audio recording. Yet, it is tedious and time-intensive to search through the lines and lines of source code in order to extract the audio files and their content that a voice recording professional will need to prepare audio segments, and it is very difficult during application development to maintain and keep synchronized a list of segments managed in a document separate from the source code.

Adding to this difficulty is the number of repetitive segments that appear frequently in IVR source code. Presently, an application developer has to manually identify duplicate audio text segments and, in order to reduce the time and cost associated with the use of a voice professional and to reduce the space required for the application on a server, eliminate these repetitive segments. It is not cost productive to provide a voice professional with code containing duplicative audio segment text that contains embedded timed pauses and variables and expect the professional to quickly and accurately prepare audio messages based upon the code.

Further, many speech application developers pay little attention to the effects of co-articulation when preparing code that will ultimately be turned into recorded or text-to-speech audio responses. Co-articulation problems occur in continuous speech since articulators, such as the tongue and the lips, move during the production of speech but due to the demands on the articulatory system, only approach rather than reach the intended target position. The acoustic result of this is that the waveform for a phoneme is different depending on the immediately preceding and immediately following phoneme. In other words, to produce the best sounding audio segments, care must be taken when providing the voice professional with text that he or she will convert directly into audio reproductions as responses in an IVR dialog.

It is therefore desirable to have an automated system and method that identifies audio content in a speech application program, and extracts and processes the audio content resulting in a streamlined and manageable file recordation plan that allows for efficient recordation of the planned audio content. Notably, in co-pending U.S. patent application Ser. No. 10/730,540 entitled AUTOMATIC IDENTIFICATION OF OPTIMAL AUDIO SEGMENTS FOR SPEECH APPLICATIONS, a method, system and apparatus is shown which addresses the automatic extraction and processing of audio content resulting in a streamlined and manageable file recordation plan that allows for efficient recordation of the planned audio content.

In the method, system and apparatus disclosed in the co-pending application, however, intonation cues are not accounted for so that two audio segments of similar content, but having different intonations due to embedded punctuation can be treated as the same segment. In as much as two audio segments are treated as the same segment, the optimization component of the invention of the co-pending application can result in the elimination of those audio segments viewed as redundant in the file recordation plan. Yet, two audio segments having the same textual content, but requiring a different intonation based upon a corresponding punctuation directive can require different recordings to account for the different intonations.

### SUMMARY OF THE INVENTION

The present invention addresses the deficiencies of the art in respect to the automatic identification of optimal audio segments in speech applications and provides a novel and non-obvious method, system and apparatus for the automatic capture of intonation cues in audio segments in speech applications. In accordance with the present invention, a method for automatically capturing intonation cues in audio segments in speech applications can include identifying planned audio segments in the speech application program, the audio segments containing audio text to be recorded and associated file names. The method further can include extracting the audio segments from the speech application program and processing the extracted audio segments to create an audio text recordation plan. Finally, the method can include further processing the audio text recordation plan to account for intonation cues.

In a preferred aspect of the invention, the step of further processing the audio text recordation plan can include locating intonation cues within audio segment text in the planned audio segments and re-forming names for corresponding audio files to account for the located intonation cues. In this regard, the intonation cues include cues selected from the group consisting of exclamation points, question marks, commas, periods, colons and semi-colons. In any case, the method further can include identifying codes corresponding to the located intonation cues and performing the re-forming step using the identified codes.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a system, method and apparatus for automatically capturing intonation cues in audio segments for speech applications according to the inventive arrangements; and,

FIGS. 2A and 2B, taken together, are flow charts illustrating a process for automatically capturing intonation cues in audio segments for speech applications.

### DETAILED DESCRIPTION OF THE PREFERRED EMBODIMENTS

The present invention is a method, system and apparatus for automatically capturing and processing intonation cues in planned audio segments for use in a speech application for an interactive voice response program. In accordance with the present invention, the planned audio segments represent text that is to be recorded for audio playback resulting in “actual audio segments”. More specifically, the text can be processed to produce manageable audio files containing text that can be easily translated to audio messages.

In more particular illustration, source code for a speech application written, for example, using VoiceXML, can be analyzed and text that is to be reproduced as audio messages and all associated file names can be identified. This text then can be processed via a variety of optimization techniques that account for programmed pauses, the insertion of variables within the text, duplicate segments and the effects of co-articulation. The result is a file recordation plan in the form of a record of files that can be easily used by a voice professional to quickly and efficiently produce recorded audio segments that will be used in the interactive voice response application.

In the course of optimizing the text, duplicate file names for the planned audio segments can be grouped together through a sorting operation on the plan. The sorted listing of planned audio segments can facilitate the recording of the actual audio segments as the recording professional need only record one instance of an audio segment for the identical text. Yet, in accordance with the present invention, intonation cues can be recognized in the text so as to distinguish otherwise identical text from one another. Exemplary intonation cues include exclamation points, question marks, colons, semi-colons, commas and periods. In this way, an actual audio recording can be produced for each planned audio segment having separate intonation cues.

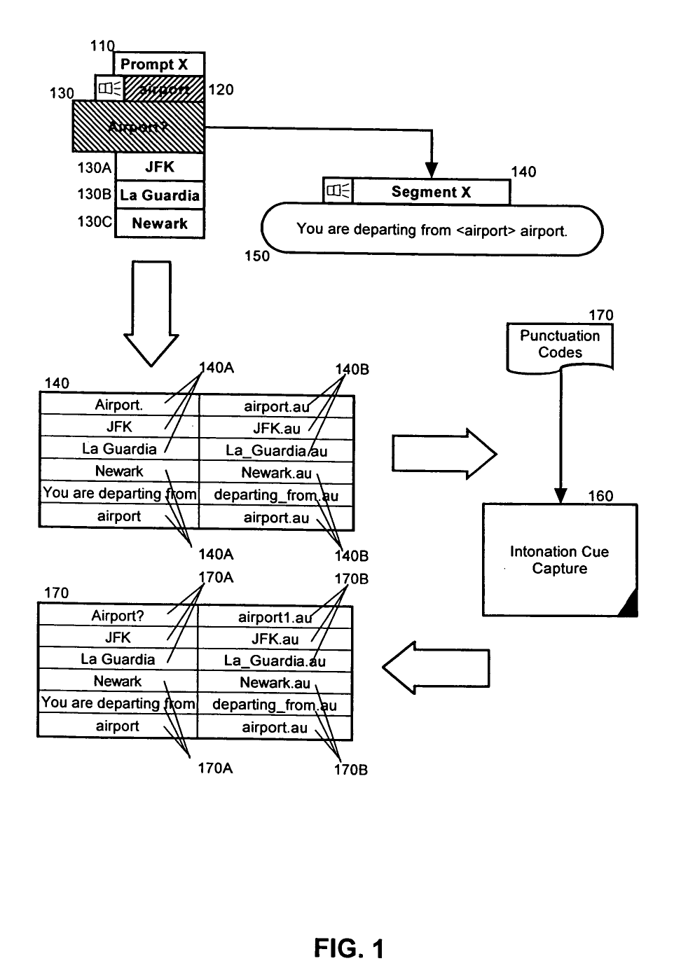

Referring to FIG. 1, a pictorial illustration of the call flow of a system, method and apparatus for automatically capturing intonation cues in audio segments for speech applications is shown. In an exemplary call flow, a prompt 110 can be defined for an audible interaction with an end user. The prompt 110 can include a label 120, non-variable playback text 130 and the variable playback text 130A, 130B, 130C. In the exemplary case, the non-variable playback text 130 can include the audible statement, “You are departing from <airport> airport.” as shown in the text 150 for the corresponding audio segment 140. The variable <airport> can be replaced with the variable playback text 130A, 130B, 130C—in this case, “JFK”, “La Guardia” and “Newark”.

Notably, in accordance with the method, system and apparatus disclosed in co-pending U.S. patent application Ser. No. 10/730,540 entitled AUTOMATIC IDENTIFICATION OF OPTIMAL AUDIO SEGMENTS FOR SPEECH APPLICATIONS, a segment table 140 specifying planned audio segments can be produced to include both audio segment text 140A and the names of corresponding audio segment files 140B. To account for intonation cues within the audio segment text 140A, however, the segment table 140 can be further analyzed in an intonation cue capturing process 160 to produce an optimized segment table 170 which accounts for intonation cues embedded within the audio segment text 170A in specifying corresponding planned audio segment files 170B.

In operation, the intonation cue capturing process 160 can inspect audio text segments 140A in the segment table 140 to locate a planned audio text segment 140A positioned at the end of a sentence. Once a planned audio text segment 140A has been identified which is positioned at the end of a sentence, the punctuation for the sentence can be extracted and compared to punctuation marks defined within a set of punctuation codes 170. A particular one of the punctuation codes 170 corresponding to the extracted punctuation mark for the sentence can be combined with the name of a corresponding one of the audio segment files 140B to produce a uniquely named audio segment file 170B. Finally, the uniquely named audio segment file 170B can be associated with the corresponding audio segment text 170A in an optimized segment table 170.

Consequently, when processing the segment table 170, the recorded audio for the audio segment text 170A can be treated differently for different intonation cues reflected in the names of the audio segment files 170B. In this regard, rather than grouping all like audio segment text 170A together as if only a single named audio segment file 170B is to be produced there for despite different intonation cues, like audio segment text 170A having different intonation cues can result in the production of different ones of the named audio segment files 170B. As a result, the optimized segment table 170 can be processed to account for different intonation cues, including an intonation of exclamation, question or statement, to name a few.

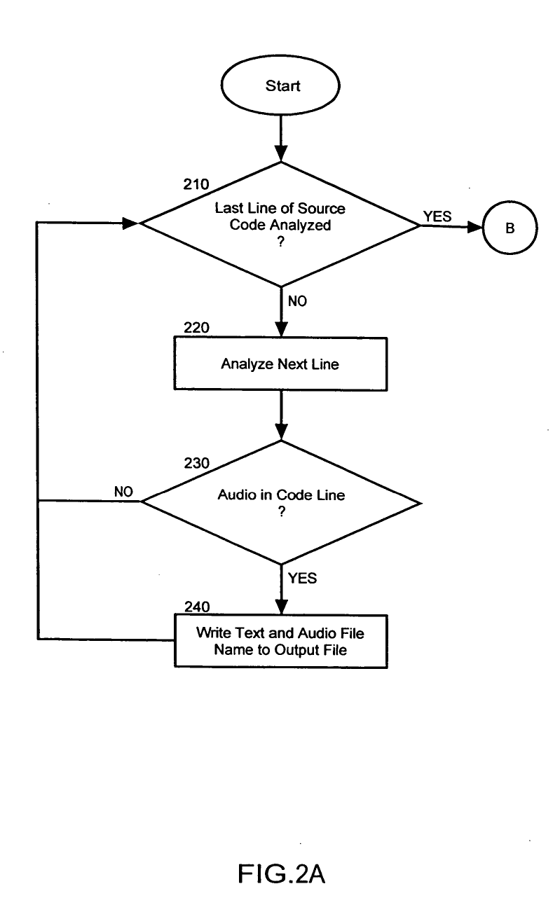

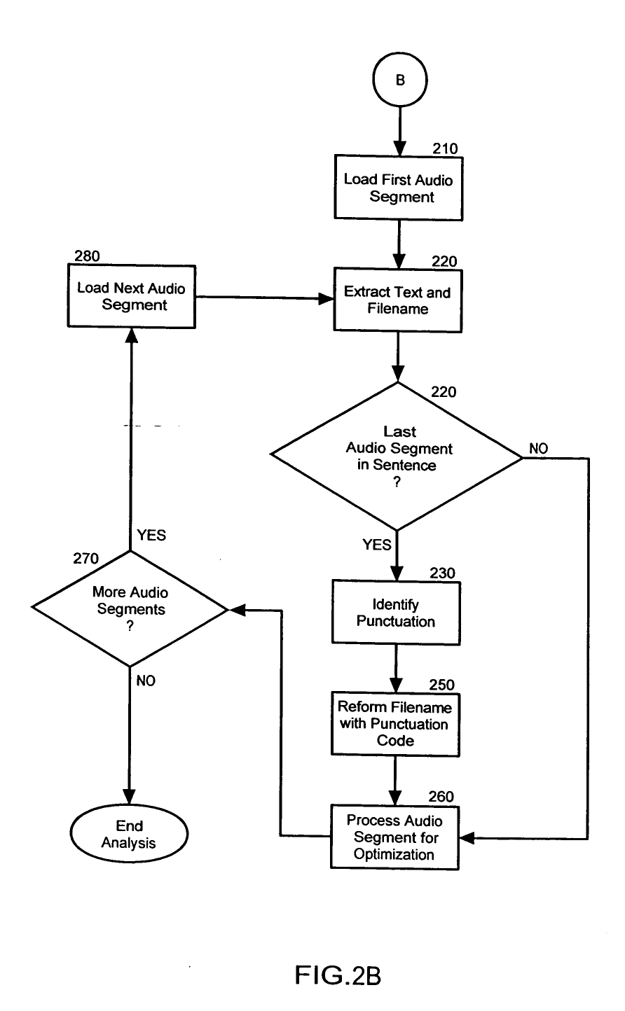

In further illustration, FIGS. 2A and 2B, taken together, are flow charts illustrating a process for automatically capturing intonation cues in audio segments for speech applications. Initially, planned audio segment text can be retrieved from the source code for the speech application. In decision block 210, it can be determined whether the retrieved text is the last line of source code in the speech application. If not, in block 220 the next line of the source code can be retrieved. In decision block 230, it can be determined if audio has been specified in the line of code. If so, in block 240 the text of the source code line and the corresponding audio file name can be written to a table of planned audio segments. Otherwise, in decision block 210, it can be determined whether a next line of source code is the last line of source code in the speech application. Again, if not, in block 220 the next line of the source code can be retrieved.

When the source code of the speech application has been analyzed so as to produce a segment table, the process can continue through jump circle B to block 210 of FIG. 2B. In block 210 the first audio segment of the table can be loaded for processing. In block 220, the text of the audio segment and a corresponding file name for planned audio can be extracted from the first audio segment. In decision block 220, it can be determined if the audio segment is the last audio segment of a phrase or sentence. To that end, punctuation marks can be instructive in identifying textual breaks in a phrase or sentence as will be recognized by the skilled artisan.

If in decision block 220 it is determined that the first audio segment is not the last audio segment in a phrase or sentence, in decision block 260 the audio segment can be processed for optimization, for example in accordance with the optimization taught in co-pending U.S. patent application No. 10/730,540 entitled AUTOMATIC IDENTIFICATION OF OPTIMAL AUDIO SEGMENTS FOR SPEECH APPLICATIONS. Otherwise, in block 230 the punctuation mark associated with the audio segment can be identified. Consequently, in block 250 the file name of the audio segment can be reformed using a punctuation code which corresponds to the identified punctuation mark. Subsequently, the process can continue through block 260 in which the audio segment can be processed for optimization.

In decision block 270, it can be determined if additional audio segments remain to be processed in the table. If so, in block 280 the next audio segment in the table can be loaded for consideration and the process can continue through block 220 as before. Otherwise, the analysis can end. In any event, through a processing of the segment table for intonation cues, it can be assured that any optimization and compression performed upon the audio segments will account for different intonation cues associated with the segments and will not treat all like audio segments alike despite differences in intonation cues.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

1. A method of automatically capturing intonation cues in audio segments for speech application programs, the method comprising:
identifying planned audio segments in the speech application program, the audio segments containing audio text to be recorded and associated file names;
extracting the audio segments from the speech application program;
processing the extracted audio segments to create an audio text recordation plan; and,
further processing the audio text recordation plan to account for intonation cues.

2. The method of claim 1, wherein the step of further processing the audio text recordation plan comprises the steps of:
locating intonation cues within audio segment text in the planned audio segments; and,
re-forming names for corresponding audio files to account for the located intonation cues.

3. The method of claim 2, further comprising the steps of:
identifying codes corresponding to the located intonation cues; and,
performing the re-forming step using the identified codes.

4. The method of claim 2, wherein the intonation cues include cues selected from the group consisting of exclamation points, question marks, commas, periods, colons and semi-colons.

5. The method of claim 1, wherein the processing step comprises the steps of:
determining if the extracted audio segment contains more than one sentence of audio text; and
modifying the extracted audio segments to obtain audio segments containing only one sentence of audio text, if the extracted audio segments contain more than one sentence of audio text.

6. The method of claim 5, wherein the processing step further comprises the step of sorting the extracted audio segments.

7. The method of claim 6, wherein the processing step further comprises the steps of:
identifying an initial audio segment containing audio text;
identifying duplicate audio segments containing a corresponding audio file name identical to an audio file name for the initial audio segment; and
deleting the duplicate audio segments.

8. The method of claim 1, wherein the speech application program language is VoiceXML.

9. A machine readable storage having stored thereon a computer program for automatically capturing intonation cues in audio segments in a speech application program, the computer program comprising a routine set of instructions which when executed by a machine cause the machine to perform the steps of:
identifying planned audio segments in the speech application program, the audio segments containing audio text to be recorded and associated file names;
extracting the audio segments from the speech application program;
processing the extracted audio segments to create an audio text recordation plan; and,
further processing the audio text recordation plan to account for intonation cues.

10. The machine readable storage of claim 9, wherein the step of further processing the audio text recordation plan comprises the steps of:
locating intonation cues within audio segment text in the planned audio segments; and,
re-forming names for corresponding audio files to account for the located intonation cues.

11. The machine readable storage of claim 10, further comprising a routine set of instructions which when executed by the machine further cause the machine to perform the steps of:
identifying codes corresponding to the located intonation cues; and,
performing the re-forming step using the identified codes.

12. The machine readable storage of claim 10, wherein the intonation cues include cues selected from the group consisting of exclamation points, question marks, commas, periods, colons and semi-colons.

13. The machine readable storage of claim 9, wherein the processing step comprises the steps of:
determining if the extracted audio segment contains more than one sentence of audio text; and
modifying the extracted audio segments to obtain audio segments containing only one sentence of audio text, if the extracted audio segments contain more than one sentence of audio text.

14. The machine readable storage of claim 13, wherein the processing step further comprises the step of sorting the extracted audio segments.

15. The machine readable storage of claim 14, wherein the processing step further comprises the steps of:
identifying an initial audio segment containing audio text;
identifying duplicate audio segments containing a corresponding audio file name identical to an audio file name for the initial audio segment; and
deleting the duplicate audio segments.

16. The machine readable storage of claim 9, wherein the speech application program language is VoiceXML.

17. A system for automatically capturing intonation cues in audio segments in a speech application program, the audio segments containing audio text to be recorded and associated file names, the system comprising a computer having a central processing unit, the central processing unit extracting audio segments from a speech application program, processing the extracted audio segments in order to create an audio text recordation plan, and further processing the audio text recordation plan to account for intonation cues.

18. The system of claim 17, wherein further processing the audio text recordation plan comprises locating intonation cues within audio segment text in the planned audio segments; and, re-forming names for corresponding audio files to account for the located intonation cues.

19. The system of claim 18, wherein the central processing unit further identifies codes corresponding to the located intonation cues; and, performs the re-forming using the identified codes.

20. The system of claim 18, wherein the intonation cues include cues selected from the group consisting of exclamation points, question marks, commas, periods, colons and semi-colons.
